(19) United States
(12) Patent Application Publication
(10) Pub. No.: US 2008/0008409 A1
(43) Pub. Date: Jan. 10, 2008

(54) Brushless DC motor structure

(75) Inventors: Alex Hong, Kaohsiung City (TW); Shih Chang Huang, Kaohsiung City (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung City (TW)

(21) Appl. No.: 11/498,061

(22) Filed: Aug. 3, 2006

(30) Foreign Application Priority Data
Jul. 4, 2006 (TW) 95124302

(51) Int. Cl. F16C 33/74

(52) U.S. Cl. 384/130

(57) ABSTRACT

The present invention relates to a brushless DC motor structure providing at least a dust-filtering element between a holder of a rotor and a bearing. The dust-filtering element is made of a porous and absorbent material and nearly or slightly contacts with the holder and a spindle. As such, when particles and dust in air enter the motor structure to be completely filtered, blocked, and absorbed by the porous dust-filtering element, no particles and dust will get into the spindle seat to be mixed with lubricant in formation of oil sludge, thereby ruling out the blocking and locking issue of the spindle arising from the oil sludge and prolonging the operation life span of the motor.

### FIELD OF THE INVENTION

The present invention relates to a brushless DC motor structure, and more particularly to a structure using a dust-filtering element to prevent the ingress of particles and dust into a spindle seat of a motor.

### BACKGROUND OF THE INVENTION

A conventional brushless DC motor structure is illustrated in FIG. 1, in which the motor includes a base 31, a stator 32 and a rotor 33.

A spindle seat 1 is centrally disposed in the base 31 and accommodates at least a bearing 11. A spindle 12 is centrally buried in a holder 34 of the rotor 33. The spindle 12 passes through the bore of the bearing and a fastener is fixed in an angular groove 13 on the spindle 12, such that the rotor 33 can be loosely integrated on the base 31.

The bearing itself and the spindle seat 1 all contain lubricant therein. Hence, when the rotor 33 rotates, lubricant will sequentially follow the path of the inner wall of the bore of the bearing 11, the top side of the bearing 11, a bevel 16 on a top periphery of the bearing 11 to flow in between the bearing 11 and the spindle seat 1 and is recirculated back in the bearing 11. As a result, a self-initiating circulation of lubricant can be generated, and the surface inside the bore of the bearing 11 gets lubricated to reduce attrition between the bearing 11 and the spindle 12 and lower noise arising from motor rotation.

Whereas, during actual operation of the aforementioned conventional brushless DC motor structure, lubricant contained in the bearing itself and the spindle seat is easily splashed out the spindle seat 1 because an excessively large gap is present between the holder 34 of the spindle 12 and the inner wall of the spindle seat 1. Meanwhile, the ingress of particles and dust in air into the spindle seat 1 also become easy. After dust and particles fall onto the top side of the bearing 11 with lubricant, the accumulated particles and dust are mixed with lubricant to form a thick and sticky oil sludge, which is gradually deposited on the bearing 11 and the surface of the spindle 12 to result in a rough lubricant circulation as the sludge is moved by lubricant on the top side of the bearing 11. As a consequence, the blockage of lubricant circulation due to the sludge further gives rise to insufficient lubrication between the bearing 11 and the spindle 12, which leads to various issues like lower rotation speed of the rotor 33, noise and high temperature resulting from attrition, and so forth. When such issue is overwhelming, the spindle 12 will even get locked and the operation duration of motor is lowered.

Moreover, as shown in FIG. 2 indicative of Republic of China patent no. 588809 “Dustproof and leakproof structure of bearing”, at least a bearing 11 is disposed in a spindle seat 1, a spindle 12 is pivotally connected with the bearing to rotate therein, an end of the spindle 12 passing through the bearing 11 has an angular groove 13 thereon, a fastener is applied to the angular groove to fix the spindle 12 and prevent it from working loose.

The present invention is characterized by having a ring 2 disposed around a location of the spindle 12 above the bearing 11 and a plurality of washers 15. The ring 2 has a hole at the center, which is tightly fitted with a spindle 12 and is integrally rotated with the spindle 12. The circumferential edge 22 of the ring 2 nearly or slightly contacts with the inner wall of the spindle seat 1. As such, an oil film contact will be naturally formed in the minimum gap between the circumferential edge of the ring 2 and the spindle seat. The oil film is used to prevent particles and dust from entering and prevent lubricant from leaking simultaneously.

Although the aforementioned conventional structure can effectively prevent lubricant from leaking, the dustproof effect is hardly outstanding. Despite the ring 2 made of soft material such as rubber and the like, while the spindle rotates, a friction force will still be generated if the ring contacts with the inner wall of the spindle seat 1. The friction force not only lessens rotation speed of the spindle 12 but also results in starting difficulty of motor when the motor is in a still state and intends to start up. Therefore, while practically producing such ring 2, larger clearance tolerance will be reserved to prevent the ring 2 from directly contacting with the spindle seat 1 in an attempt to rule out the mentioned problem.

Notwithstanding the structure, it impacts on the dustproof function of the ring 2 in a negative manner. Particles and dust in air still go through the gap between the circumferential edge 22 and the inner wall of the spindle seat 1 to get into the spindle seat 1 and are mixed with lubricant to form oil sludge that further blocks lubricant circulation and leads to a multitude of problems such as reduced rotation speed, noise, high temperature arising from friction and so on.

Consequently, to effectively avoid the ingress of particles and dust into the spindle seat in an effort to prevent the spindle from being blocked and locked due to the oil sludge and to prolong life cycle of motor, instead of a passive isolation, a better dustproof technique, one particularly for blocking and absorbing particles and dust, needs to be found elsewhere for serving as a total solution to the aforementioned issues indeed.

### SUMMARY OF THE INVENTION

In view of the foregoing concern, the present invention thus provides a brushless DC motor structure, which includes a base, a stator and a rotor.

A spindle seat is centrally disposed in the base,, the stator is disposed on a periphery of the spindle seat, and at least a bearing is disposed inside the spindle seat.

The rotor has a holder at the center thereof. A spindle is buried in the holder and passes through the bore of the bearing such that the rotor can be loosely integrated with the base.

The present invention is characterized by having a plurality of dust-filtering element disposed between the holder of the rotor and the bearing, the dust-filtering elements are porous and are made of a material with absorbent function, and the dust-filtering element nearly or slightly contacts with the holder and the inner surface of the spindle seat.

As such, particles and dust in air will be completely filtered, blocked and absorbed by the porous dust-filtering element without entering the inner part of the spindle seat to mix with lubricant in formation of oil sludge. The issue that the spindle is blocked and locked can be prevented, and the operation life span of the motor can be prolonged.

### BRIEF DESCRIPTION OF THE DRAWINGS

FIG. 1 is a cross-sectional view showing a conventional brushless motor structure;

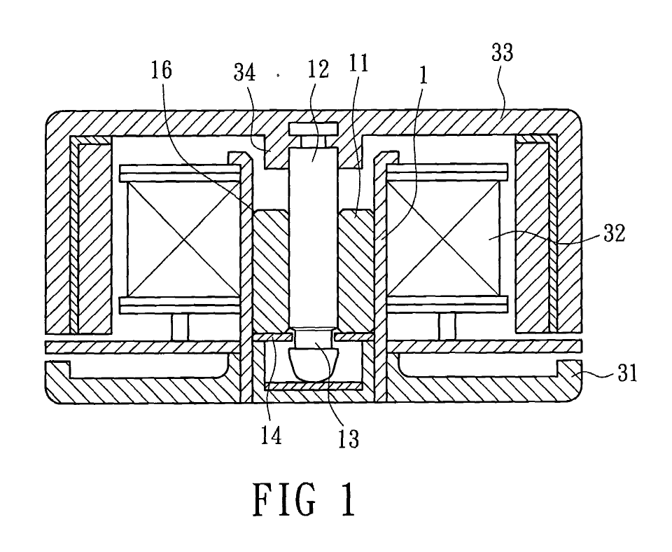

FIG. 2 is a cross-sectional view illustrative of Republic of China patent no. 588809; and

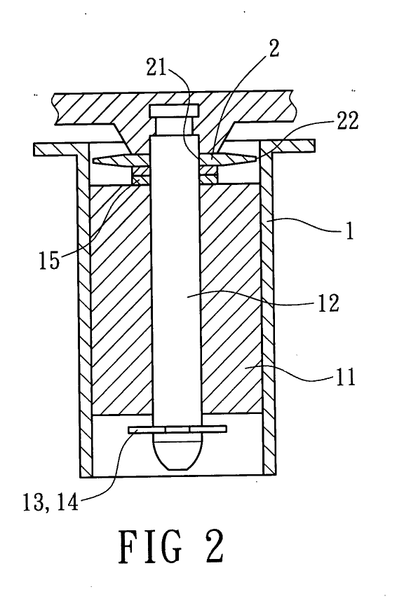

FIG. 3 is a cross-sectional view of the present invention.

### DETAILED DESCRIPTION OF THE PREFERRED EMBODIMENT

The present invention relates to a brushless DC motor structure, which utilizes a porous dust-filtering element having absorbent function to prevent the ingress of particles and dust into the inner part of a motor spindle seat and prevent the spindle from being blocked and locked by the spindle, so as to prolong the operation life span of the motor.

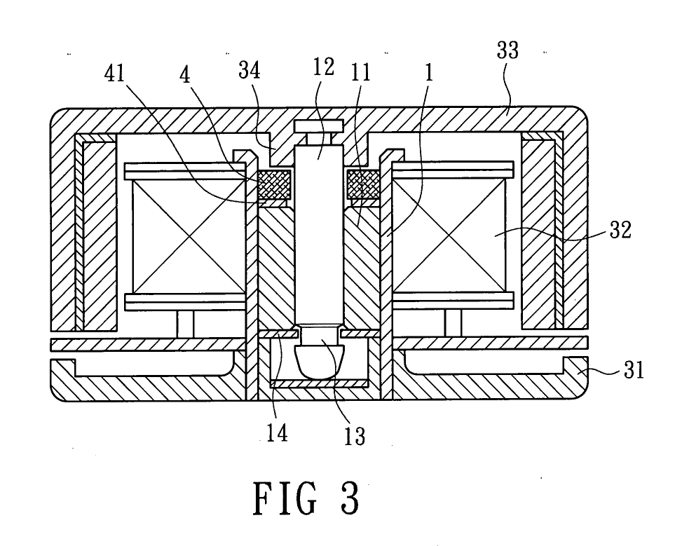

Please refer to FIG. 3, the brushless DC motor structure contains a base 31, a stator 32 and a rotor 33, wherein a spindle seat 1 is centrally disposed in the base 31, a stator 32 is disposed on a periphery of the spindle seat 1, at least a bearing 11 is contained in the spindle seat 1, and a locating ring 41 is disposed above the bearing.

A holder 34 is centrally formed in the stator 33. A spindle 12 is buried in the holder 34. The spindle 12 can pass through the bore of the bearing 12, and a fastener 14 is fixed in an angular groove 13 of the spindle 12, such that the rotor can be loosely integrated with the base 31.

The present invention is characterized by having a plurality of dust-filtering elements 4 disposed between the holder 34 of the rotor 33 and the bearing 11 inside the spindle seat 1. The dust-filtering element can be made of a porous and absorbent material such as sheep felt, sponge, non-woven cloth and the like and nearly or slightly contacts with the holder 34 of the rotor and the inner surface of the spindle seat 1.

When motor rotates, lubricant inside the spindle seat 1 is driven by rotation of the spindle 12 to self-generate a circulation effect providing a pump suction force inside the spindle seat 1 to suck particles and dust in air in the spindle seat 1. Being filtered, blocked and absorbed by the porous dust-filtering element 4, particles and dust won't get into the spindle seat 1, nor will they be mixed with lubricant to form oil sludge. Certainly, there will be no blocking and locking issue of the spindle arising from oil sludge either.

Even though the material such as sheep felt, sponge, non-woven cloth and the like slightly contacts with the holder 34 of the rotor 33 while motor is rotating, rotation speed of the spindle 12 won't be affected or slowed down, and after the material such as sheep felt, sponge, non-woven cloth and the like slightly contacts with and rubs against the holder 34 of the rotor 33, electrostatic charge will be generated to attract, filter and absorb particles and dust so as to attain an optimal dustproof effect and prolong the life cycle of motor.

By means of the mentioned design, instead of passive dust isolation only, the present invention also provides the functions for blocking, filtering and absorbing particles and dust, which can effectively and surely prevent the ingress of particles and dust in air into the spindle seat. The issue that the spindle is blocked and locked by oil sludge is avoided, and the motor operation life cycle is prolonged. Therefore, the present invention not only has a novelty and a progressiveness, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A brushless DC motor structure, comprising:
a base centrally provided a spindle seat;
a bearing accommodated in said spindle seat;
a stator disposed on a periphery of said spindle seat;
a rotor centrally provided a holder;
a spindle fixed in said holder and passing through a bore of said bearing for said rotor to be loosely bundled with said base;
at least a dust-filtering element disposed between said holder of said rotor and said bearing and inside said spindle seat, made of-a porous and absorbent material, and nearly or slightly contacting with said holder of said rotor and an inner surface of said spindle seat.

2. The brushless DC motor structure of claim 1, wherein said dust-filtering element is made of sheep felt.

3. The brushless DC motor structure of claim 1, wherein said dust-filtering element is made of sponge.

4. The brushless DC motor structure of claim 1, wherein said dust-filtering element is made of non-woven cloth.

5. The brushless DC motor structure of claim 1, wherein a locating ring is disposed between a top place of said bearing and said dust-filtering element.

6. The brushless DC motor structure of claim 1, wherein an end portion of said spindle passing through said bore of said bearing has an angular groove fastened by a fastener.
